(19) United States
(12) Patent Application Publication
(10) Pub. No.: US 2006/0082528 A1
(43) Pub. Date: Apr. 20, 2006

(54) Organic light emitting diode circuit having voltage compensation function and method for compensating

(75) Inventors: Hong-Ru Guo, Tainan City (TW); Chen-Chung Yang, Tainan City (TW); Ming-Chun Tien, Tainan (TW)

Correspondence Address: TUNG & ASSOCIATES, Suite 120, 838 W. Long Lake Road, Bloomfield Hills, MI, 48302, US

(73) Assignee: Chi Mei Optoelectronics Corp.

(21) Appl. No.: 11/247,106

(22) Filed: Oct. 11, 2005

(30) Foreign Application Priority Data
Oct. 13, 2004 (TW) 093130956

(51) Int. Cl. G09G 3/32

(52) U.S. Cl. 345/82

(57) ABSTRACT

In organic emitting diode circuit that is equipped with voltage compensation function and a method for compensating voltage in the organic light emitting diode circuit are presented. The circuit includes a first transistor, a pixel control unit, a precharge control component and an OLED. The present invention OLED presents numerous benefits when compared to conventional OLED such as the present invention OLED can be designed as a common cathode component such that it has improved aperture ratio, it enables array testing of the circuit before the fabrication process is completed, and it allows color and brightness compensation in addition to voltage compensation.

### TECHNICAL FIELD

The present invention generally relates to a light emitting device and circuits driving the light emitting device, and a method for operating the circuit and more particularly, relates to an organic light emitting diode circuit that incorporates voltage compensation function and a method for compensating the voltage of the circuit.

### BACKGROUND OF THE INVENTION

Organic light emitting diodes (OLEDs) are typical light emitting elements currently seen as promising for all types of display devices. OLED display devices that use OLED elements as light emitting elements are thinner and lighter than existing liquid crystal display devices, and in addition, have characteristics such as high response speed suitable for dynamic image display, a wide angle of view, and low voltage drive. A wide variety of applications are therefore anticipated, from portable telephones and personal digital assistant (PDAs) to televisions, monitors, and the like. OLED display devices are under the spotlight as next generation displays.

In particular, active matrix (AM) OLED display devices are capable of high resolution (large number of pixels), high definition (fine pitch), and a large screen display, all of which are difficult for passive matrix (PM) type displays. In addition, AM-OLED display devices have high reliability at lower electric power consumption operation than that of passive matrix OLEDs, and there are very strong expectations that they will be put into practical use.

The term display device as used in this specification indicates devices in which a plurality of pixels are arranged in a matrix shape, and image information is visually transmitted, namely displays.

In an OLED pixel circuit, thin film transistors (TFT) are frequently used which present numerous advantages and disadvantages. A thin film transistors (TFT) display is a type of LCD flat-panel display screen, in which each pixel is controlled by a small number of transistors, typically from one to four transistors. TFT technology provides the best resolution of all the current flat-panel techniques. TFT screens are sometimes called active-matrix LCDs.

A conventional OLED pixel circuit 10 that incorporates a voltage compensation function and a corresponding timing sequence chart are shown in FIGS. 1A and 1B. The OLED pixel circuit 10 is formed by transistors 26, 28, and 30, capacitor 32, and OLED 34. Before data is written into the circuit 10, a second scan line SL2j 18 changes from an initial low voltage potential to a high voltage potential to enable transistor 28 in a conducting state for setting the threshold voltage of transistor 30. After data is written into the circuit, the second scan line SL2j 18 resumes its original low voltage potential, and simultaneously, a first scan line SL1j 16 is set to a high voltage potential in order to place transistor 26 into a conducting state. The data is then delivered to the gate terminal of transistor 30 such that OLED 34 can be excited to generate light.

In operation, the conventional circuit shown in FIGS. 1A and 1B has variations in the signal waveform at node COM of OLED 34 that are not uniform and cannot be easily controlled. This is because the current flowing through the driving transistor 30 may vary as a function of a threshold voltage. Thus, the current flowing through the OLED is not held constant.

As a result, dispersion, not uniformity, in the electrical characteristics of the driver transistors across each of the pixels when the OLED elements do not emit light at a constant current, then dispersion will develop in the OLED element driver current of each of the pixels. Dispersion in the OLED element driver current becomes dispersion in the brightness of light emitted from the OLED elements. Dispersion in the brightness of light emitted by the OLED elements reduces the quality of the displayed image as a sandstorm state or carpet-like pattern unevenness is seen over an entire screen. Stripe shape unevenness is also found, depending upon the manufacturing process.

Moreover, before the completion of the fabrication process for OLED 34, an array test for transistors 28, 30, in the circuit cannot be carried out. One other disadvantage of the OLED 34 circuit is that the circuit cannot be designed as a common cathode component. Thus, because of the varying current flow through the OLED, voltage measured at COM may also be irregular. Consequently, when an OLED pixel circuit 10 is placed in an array of similar circuits to form an active-matrix LCD, varying voltages and current at COM make it difficult to provide a common ground to each of the pixel circuits located in the array. As a result, the aperture ratio of the component is affected. The aperture ratio is the actual light-transmitting area against the theoretical sub-pixel size calculated with active area and resolution.

One of the disadvantages in utilizing thin film transistors in an OLED pixel circuit is the long driving time required to drive the pixel circuit. A long driving time can lead to threshold voltage swings in the transistors driving the pixel circuit. Current flowing through the driving TFT's also fluxuates as a result of such voltage swings. The brightness and intensity of an OLED is directly proportional to the flow of current through the OLED, thus, a change in current flow through an OLED can cause fluxuations in the brightness and intensity of the OLED. A flat panel display having a plurality of OLEDs may have irregularities in brightness and intensity when the current flow through each OLED is not held constant but instead fluxuates in response to voltage swings in each driving TFT that drive each OLED.

It is therefore desirable, in the design of an OLED pixel circuit, to incorporate a method of compensating for voltage threshold swings to control the current flowing through the driving TFT of the OLED pixel circuit.

It is therefore an object of the present invention to provide an OLED circuit that incorporates a voltage compensation function.

It is another object of the present invention to provide an OLED pixel circuit that incorporates voltage compensation function which can be designed to allow a constant current to flow through the pixel OLED circuit.

It is another object of the present invention to provide an array of OLED pixel circuits that share a common cathode.

It is an object of the present invention to improve the aperture ratio of an array of OLED pixel circuits.

It is still another object of the present invention to provide an OLED circuit equipped with voltage compensation function that can be tested in an array test before the fabrication process of the circuit is completed.

### SUMMARY OF THE INVENTION

An OLED pixel circuit is generally provided having an OLED and an OLED pixel driver circuit that compensates for voltage threshold swings in the OLED pixel driver circuit by providing a controlled current flow through the driving OLED pixel driving circuit. The OLED pixel circuit provides a plurality of TFTs provide a voltage compensation function. The voltage compensation function operates to provide a constant current to flow through the pixel OLED circuit.

In a preferred embodiment, the OLED pixel circuit having a voltage compensation function incorporated therein is placed in an array of similar circuits, wherein the array of OLED pixel circuits share a common cathode and operate to form an OLED matrix display. The matrix having the shared of the common cathode in the OLED pixel circuit array provides an improved aperture ratio over an aperture ratio of displays that do not have OLED pixel circuits with voltage compensation functions. Additionally, the common cathode allows for an array test before the fabrication process of the circuit is completed.

In a preferred embodiment, the circuit includes a first transistor, a pixel control unit, a control component, and an organic light emitting diode. The first transistor has a first terminal for receiving a supply voltage signal, and a second terminal for receiving a second scan line. The pixel control unit receives a second scan line and a data signal, and is coupled to the third terminal of the first transistor. The control component has a first terminal coupled to the pixel control unit, and second terminal connected to a precharge signal. The organic light emitting diode has a first terminal coupled to a pixel control unit, and a second terminal coupled to ground.

In a preferred embodiment, the controlled component is another transistor which has a first terminal coupled to the pixel control unit, a second terminal coupled to the first terminal of the transistor, and a third terminal for receiving a precharge signal. The pixel control unit includes a second transistor, a third transistor and a capacitor. A first terminal of the second transistor is used to receive data signal, a second terminal is used to receive a first scan line. The third transistor has a first terminal that is coupled to the third terminal of the first transistor, a second terminal coupled to the third terminal of the second transistor, a third terminal coupled to the a first terminal of the OLED and the first terminal of the controlled component. The capacitor has a first end coupled to the third terminal of the second transistor, a second terminal coupled to the third terminal of the third transistor.

In the preferred embodiment of the present invention, the OLED circuit equipped with voltage compensation function may further include a voltage comparator unit, a memory unit and a data compensation unit. For instance, the voltage comparator unit is coupled to the second terminal of the controlled component for receiving a voltage signal and outputting a comparison signal. The memory unit is used to store an initial value of the voltage signal, and to provide the initial value of the voltage signal to the voltage comparator unit. The data compensation unit is used to receive, and based on the comparison signal, to output a compensation signal such that the voltage value of the data signal may be adjusted. The controlled component used in the preferred embodiment may be an optoelectronic component.

The present invention is further directed to a method for voltage compensation for a organic light emitting diode circuit which enables the forming of a common cathode component and thus improves the aperture ratio of the pixel circuit. The method further provides the benefit that in array tests on the circuit can be conducted prior to the completion of the fabrication process for the OLED.

The method can be carried out by first setting the second scan line to a high voltage potential and the precharge signal, supply voltage signal to a low voltage potential so that the compensation voltage can be determined. The second scan line is then set to a low voltage potential to right-in the data signal. The second scan line and the supply voltage signal are then set to a high voltage potential in order to cause the excitation of the OLED.

In a second preferred embodiment of the present invention method, the method can be carried out by first setting the second scan line to a voltage potential that is sufficient to conduct through the first transistor and setting the source voltage signal and the precharge signal such that the first transistor, the pixel control unit and the control component forms a circuit loop in order to determine the compensation voltage of the pixel control unit. The second scan line is then set to a voltage potential that is sufficient to stop the flow through the first transistor, the data signal is written-in simultaneously, while the second scan line and the source voltage signal are set to a voltage potential sufficient to cause excitation of the OLED such that the OLED is in an excited state.

The present invention organic light emitting diode circuit equipped with the voltage compensation enables an OLED to be designed as a common cathode component such that the aperture ratio of the circuit can be increased. The present invention OLED that has the voltage compensation feature further allows array testing of the transistors in the circuit prior to the completion of the fabrication process for the circuit. Moreover, when circuits for voltage comparator unit, memory unit and data compensation unit are added to the OLED circuit, and an optoelectronic component is used as the control component, the brightness of the OLED can be adjusted based on the optoelectronic current value of the optoelectronic component such that the problem of color differential in the flat panel display can be avoided.

### BRIEF DESCRIPTION OF THE DRAWINGS

Embodiments of the present invention will become more fully understood from the detailed description and the accompanying drawings, wherein:

FIG. 1A is a circuit diagram for a conventional organic light emitting diode circuit having voltage compensation function.

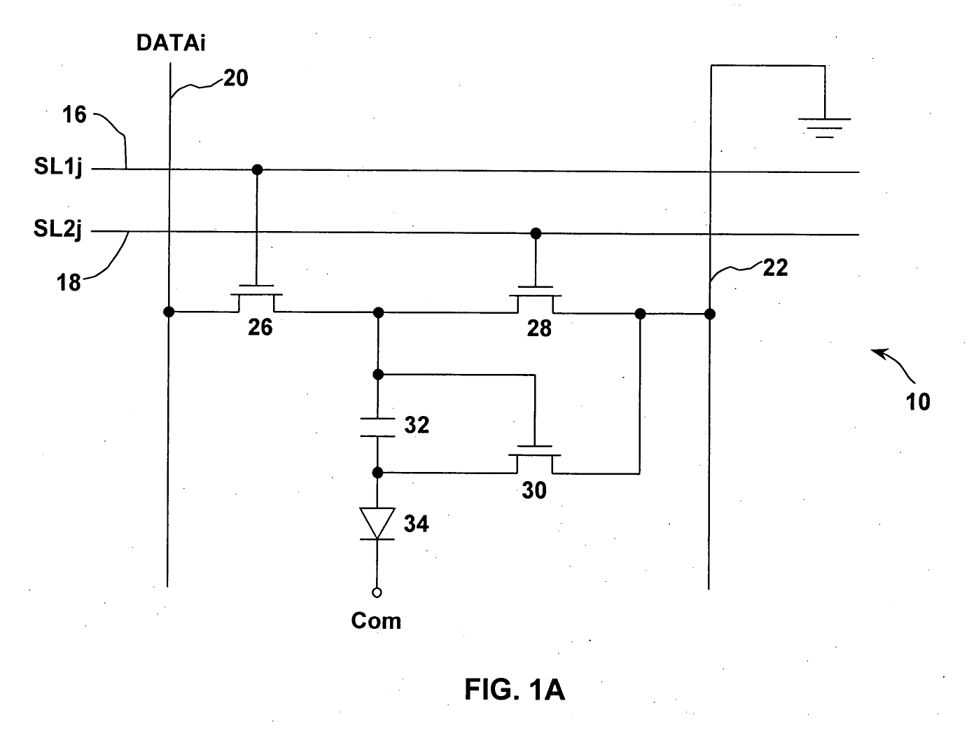

FIG. 1B is a timing sequence chart for the circuit of FIG. 1.

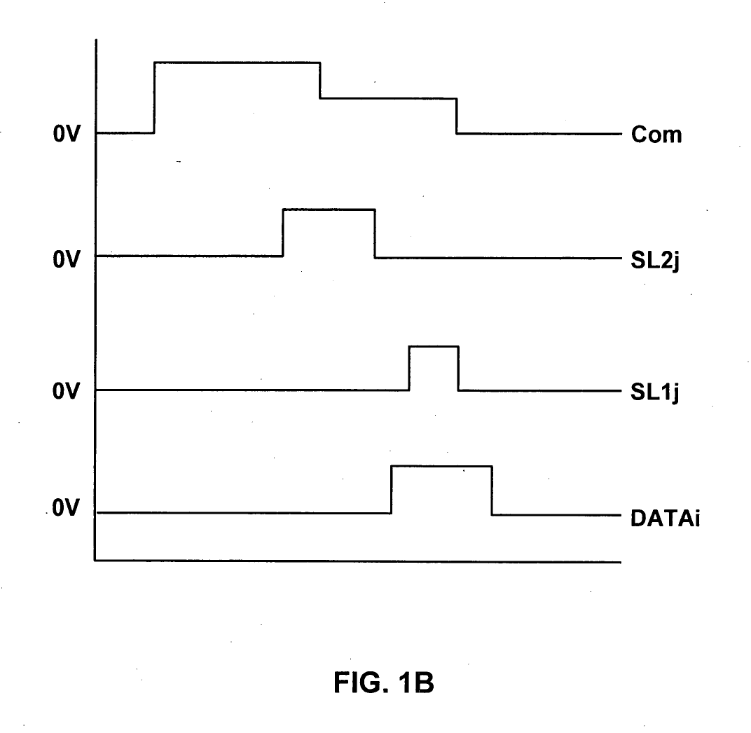

FIG. 2A is a block diagram of a preferred embodiment of the present invention organic light emitting diode circuit equipped with the voltage compensation function.

FIG. 2B is a circuit diagram of a preferred embodiment of the present invention organic light emitting diode circuit equipped with the voltage compensation function.

FIG. 2C is a timing sequence chart for the present invention circuit shown in FIGS. 2A-B.

FIG. 3A is a block diagram for a second preferred embodiment of the present invention organic light emitting diode circuit.

FIG. 3B is a circuit diagram for a second preferred embodiment of the present invention organic light emitting diode circuit.

FIG. 3C is a timing sequence chart for the second preferred embodiment of the present invention shown in FIGS. 3A-B.

FIG. 4A is a block diagram for a third preferred embodiment of the present invention organic light emitting diode circuit equipped with voltage compensation function.

FIG. 4B is a circuit diagram for a third preferred embodiment of the present invention organic light emitting diode circuit equipped with voltage compensation function.

FIG. 4C is a timing sequence chart for the third embodiment of the present invention shown in FIGS. 4A-B.

FIG. 5A is a block diagram of a fourth preferred embodiment of the present invention organic liquid emitting diode circuit equipped with a voltage compensation and color compensation function.

FIG. 5B is a circuit diagram of a fourth preferred embodiment of the present invention organic liquid emitting diode circuit equipped with a voltage compensation and color compensation function.

FIG. 7 is flow chart showing the present invention method for voltage compensation in an organic light emitting diode circuit.

### DETAILED DESCRIPTION OF THE PREFERRED EMBODIMENT

Generally provided is an OLED; and an OLED driving device in electrical communication with the OLED, wherein the OLED driving device operates to control current through the OLED during excitation of the OLED, and wherein the OLED and the OLED driving device cooperate to form a pixel circuit. More particularly, the OLED driving device provides a pixel control unit, and

a control component, wherein the control component has a first terminal coupled to the pixel control unit, and a second terminal for receiving a precharge electrical signal. The OLED has a first anode terminal coupled to the pixel control unit, and a second cathode terminal connected to ground.

A method of using the OLED and OLED driving device is also provided that provides the steps of driving the OLED by performing a setting stage, a data write-in stage, and an excitation stage.

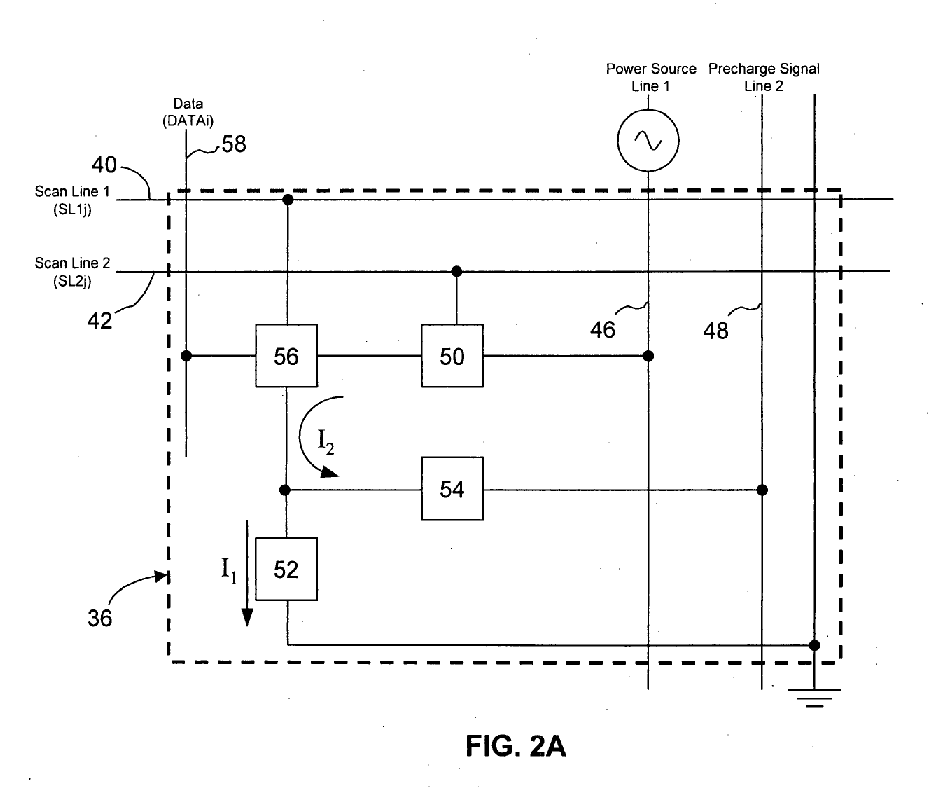

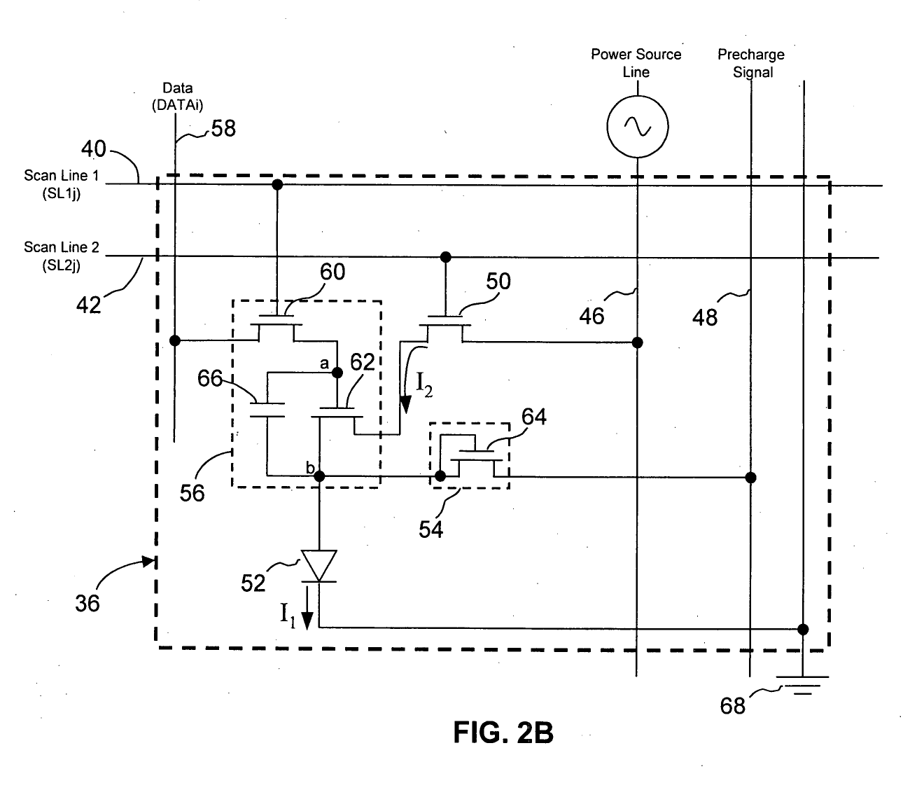

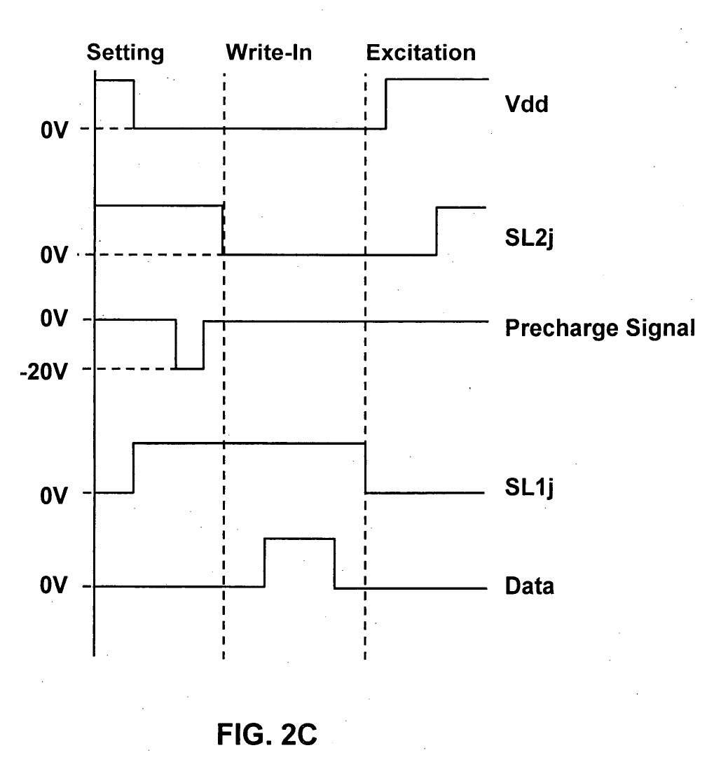

Referring now to the drawings, FIGS. 2A-B, where a block diagram, and a circuit diagram for a first preferred embodiment of the present invention organic light emitting diode circuit equipped with voltage compensation function is shown.

The pixel 36 disposed in the j-th row and the i-th column is shown in FIG. 2A. The pixel 36 has a data signal line (DATAi) 58 for receiving a voltage data signal Vdata, a power source line (Vddi) 46, a precharge signal source line 48, a first scanning line (SL1j) 40, a second scanning line (SL2j) 42, a pixel control unit 56, a first control switch 50, a precharge control component switch 54, and a light emitting element 52.

The circuit as shown in FIG. 2B is formed by a transistor 50, a pixel control unit 56, an OLED 52 and a precharge control component 54. The pixel control unit 56 is further formed by transistor 60, 62 and capacitor 66. The precharge control component 54 is formed by transistor 64.

The pixel 36 shown in FIG. 2B is the pixel 36 shown in the block diagram FIG. 2A, but shown specifically by transistors 50, 62, 64, and 66, which are all n-channel thin film transistors TFTs. This is only an example, however, and the channel types of the transistors in the block diagram are not particularly limited to these types.

The pixel control unit 56 has transistors 60, 62 and a capacitive element 66, wherein transistor 62 is a LED driver element 62. The transistor 50, corresponds to a first control switch 50, and the transistor 64 corresponds to a precharge control component switch 54. The capacitive element 66 operates to store voltage accumulated from a drain electrode of transistor 64 during operation of the pixel 36. The capacitor element 66 performs a role in storing the precharge voltage sent through the transistor 64 from the precharge signal 48.

The precharge control component, transistor 64 has a first terminal that is a drain electrode coupled to the pixel control unit 56, and a second terminal that is a source electrode for receiving a precharge electrical signal from the precharge signal line 48. The gate electrode is tied to the drain electrode of the transistor 64 to form a short circuit between the drain electrode, and the gate electrode of the transistor. 64 when a voltage corresponding to a precharge signal is sent into the source electrode of the precharge control component transistor 62.

A first control transistor 50 has a first terminal drain electrode for receiving a voltage signal from the power source line i (Vddi), a second terminal gate electrode for receiving a second scanning line signal from the SL2i, and a third terminal source electrode for coupling to the pixel control unit 56.

The light-emitting device 52 has a first anode terminal coupled to the pixel control unit 56 and a second cathode terminal cathode connected to a ground 68. More specifically, the first anode terminal of the light emitting device 52 is electrically coupled to the source electrode of transistor 62. The term light emitting device as used in this specification indicates devices that utilize light emitted from a light emitting element. Examples of the light emitting elements include organic light emitting diode (OLED) elements, inorganic material light emitting diode elements, field emission light emitting elements (FED elements) and the like. Preferably, an OLED is used in the present preferred embodiment.

In general, the pixel 36 operates in three phases, an initial setting phase, a write-in data phase, and an OLED excitation phase. Referring now to FIGS. 2A and 2B, the operation of the circuit can be illustrated in the three phases, i.e. the setting phase, the data current write-in phase and the OLED excitation phase. The setting phase is carried out before the data current write-in phase in order to set the threshold voltage for transistor 62 in the pixel control unit 56 to allow for a constant current flow through transistor 62. The setting phase sets Vs of transistor 62 at node b equal to a −Vth. In operation, the power source line voltage Vddi is changed from a high voltage potential to a low voltage potential, while the second scan line is kept at a high voltage potential in order to conduct through transistor 50. The precharge signal is set at a low voltage potential in order to conduct through transistor 64.

During the initial setting phase, transistor 62 forms a series connection relationship between transistors 50 and 64 thus allows for current to flow along current pathway 12 (not show in the figure??) during a setting phase. Transistors 50 and 64 are turned on to electrically communicate a voltage −Vth to node b. Initially, during the setting phase, the pixel control unit 56 operates to receive a first scan line signal from SL1i 40 and a data signal from DATAi 58 , and then operates to utilize the first scan line signal 40 to determine whether the data signal 58 is used to control a flow of current between the transistor 60 and the organic light emitting diode.

In the first preferred embodiment, the precharge signal is set at −20 V. A circuit loop is thus formed between transistors 50, 62 and 64 until the voltage at node b for transistor 62 is changed to a negative threshold voltage of −Vth of transistor 62. When the voltage at node b changes to −Vth, the circuit loop between transistors 50, 62 and 64 is thus broken and the second phase begins, i.e. the data current write-in phase.

During the write-in data phase, transistors 60 and 62 operate to drive the OLED 52 into an excitation phase. Additionally, transistor 62 forms a parallel connection with capacitor 66 and a series connection relationship between transistors 60 and 64, thus allowing for current to flow along current pathway I1 (not show in the figure??) during a data write-in phase.

Once excitation of the OLED 52 occurs, the pixel control unit 56 operates in an excitation phase to maintain a constant current flow through transistor 62, and to thus compensate for changes in voltage that occur in the pixel control unit.

FIG. 2C illustrates the operation of the circuit in FIG. 2A in a timing sequence chart. More particularly, in operation, during the initial setting stage, a high electronic potential signal is sent to SL2j. When the SL2j line receives the high electronic potential signal, transistor 50 turns on, making a high electronic potential signal Vdd sent to Power source line i (Vddi) decrease to a zero volt electric potential signal. When the electronic potential signal delivered to Vddi is zero, the voltage at the drain electrode Vd of transistor 62 is zero, and thus, transistor 62 remains turned off. Simultaneously, a high electronic potential signal sent to SL1j turns on transistor 60. Thus, when both the SL1j and the SL2j line each receive a high electronic potential signal, transistors 60 and 50 are both turned on, and concurrently, transistor 62 remains turned off.

When the precharge signal line 48 receives a low potential signal of zero, transistor 64 is off. However, when the precharge signal decreases or drops from the low voltage of zero to a negative voltage signal that is below a negative threshold voltage, shown as −20V in FIG. 2C, transistor 64 turns on. Once transistor 64 initially turns on, transistor 62 also turns on because the negative voltage potential signal that turned on transistor 64 passes from the source electrode of transistor 64 through the short-circuit between the gate electrode and the drain electrode of transistor 64 to the source electrode of transistor 62 at node b to turn on transistor 62.

Current I1 is enabled to flow through transistors 50, 62, 64 once transistors 60, 50, 62, 64 are turned on. Additionally current 12 is enabled to flow through transistors 60, and 62 as a gate electrode to source electrode current. Additionally, during flow of current 12 through transistors 60 and 62 during the setting phase as discussed herein, transistor 64 turns on due to the drain electrode to source electrode voltage Vds. When a low electric potential signal of zero is sent to the precharge signal line 48, the voltage of the precharge signal line increases from a voltage potential of −20V to 0V, transistor 64 turns off.

The gate electrode of transistor 64 is electrically connected to the source/drain electrode of transistor 64. Thus, when a precharge signal −20V is applied to the source electrode 64, the gate electrode is biased to turn on and will then turn off once the voltage between the source electrode and the gate electrode reaches Vth. Because the gate electrode of transistor 64 is at the same potential as the drain electrode, the voltage at node b, located between the source electrode of transistor 62, the drain electrode of transistor 64, and the capacitor 66, which stores the voltage −Vth, will also be −Vth. Once node b reaches a voltage potential of −Vth, both the transistors 64 and 62 turn off and the setting phase is complete.

When the setting phase is complete, the data write-in phase begins. During this phase after the transistor 50 turns off, data is written into the pixel control unit 56. A high electric potential signal is sent to the first scanning line (SL1j) and a low electric potential signal is sent to the second scanning line (SL2j) in the pixel 36 shown in FIG. 2B during write-in of a data current signal DATAi, preferably, DATAi is a video signal, and the transistors 60 to 62 turn on, while the transistors 50 and 64 turn off.

In the second phase, the data current write-in phase, transistor 50 is still in a non-conducting state. The precharge signal is returned to 0V thus, transistor 64 is also turned off in a non-conductive state. A data signal Vdata is then communicated to transistor 62 by transistor 60 from data line DATAi 58. Since the first scan line received by transistor 60 is a high voltage potential, Vdata is transferred to the gate terminal of transistor 62 into an excitation phase.

During the excitation phase, transistor 62 turns on and then excites the OLED 52. More particularly, after entering into the OLED excitation phase, the first scan line SL1i 40 is returned to the low voltage potential such that the transistor 60 is in a cutoff voltage region. While simultaneously Vdata is already sent to the gate terminal of transistor 62. Transistor 50, 62 then are turned on, and are in a conductive state.

The excitation of the OLED 52 occurs during the excitation phase where current flows through transistor 62, between nodes a and b in accordance with the following formulas:
I1ab=(β/2)[(Va−Vb)−Vth)² Equation 1:
Va−Vb=Vdata−(−Vth), wherein Va−Vb equals the voltage difference between nodes a and b at the terminals of transistor 62. Equation 2:

I2ab=(β/2)Vdata+Vth−Vth)²=(β/2)Vdata², wherein Equation 2 is combined into equation 1. Equation 3:

Thus, the current I2ab is independent of Vth and thus, the voltage compensation function for the threshold voltage is achieved by allowing a constant current to flow through transistor 62 to excite OLED 52.

The present invention organic light emitting diode is not only capable of providing voltage compensation function, but also enables the OLED circuit to be designed as a common cathode component, i.e. to increase the aperture ratio of the circuit. In addition, prior to the completion of the fabrication process for OLED, the current path I1 between transistors 50 and 64, and the current path 12 between transistors 60 and 64 allows an array test of the circuit.

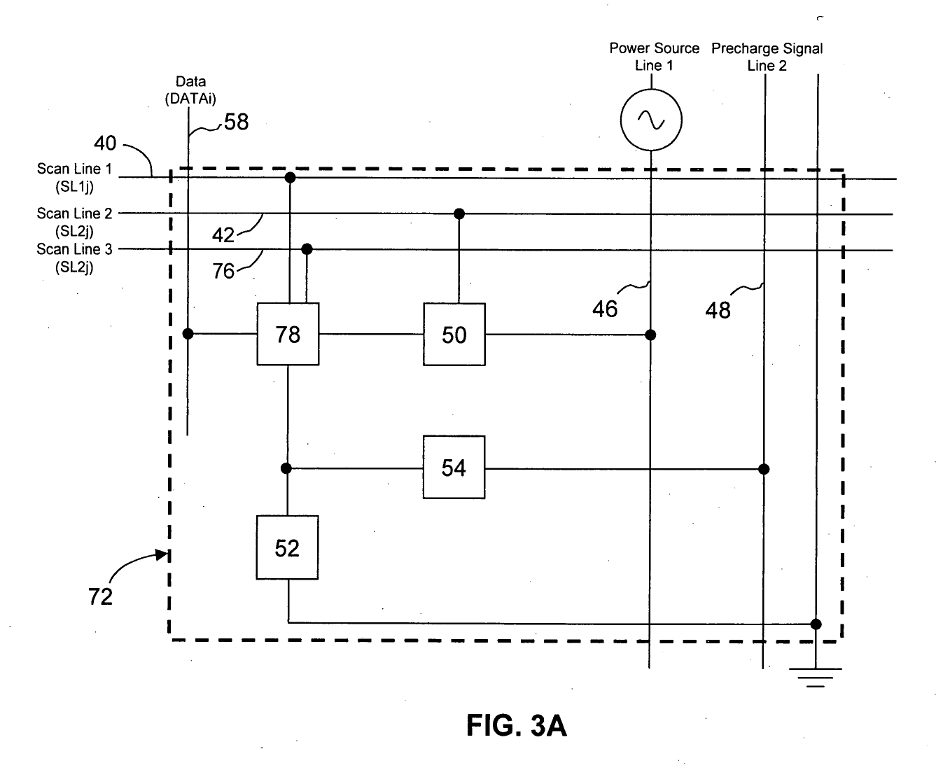

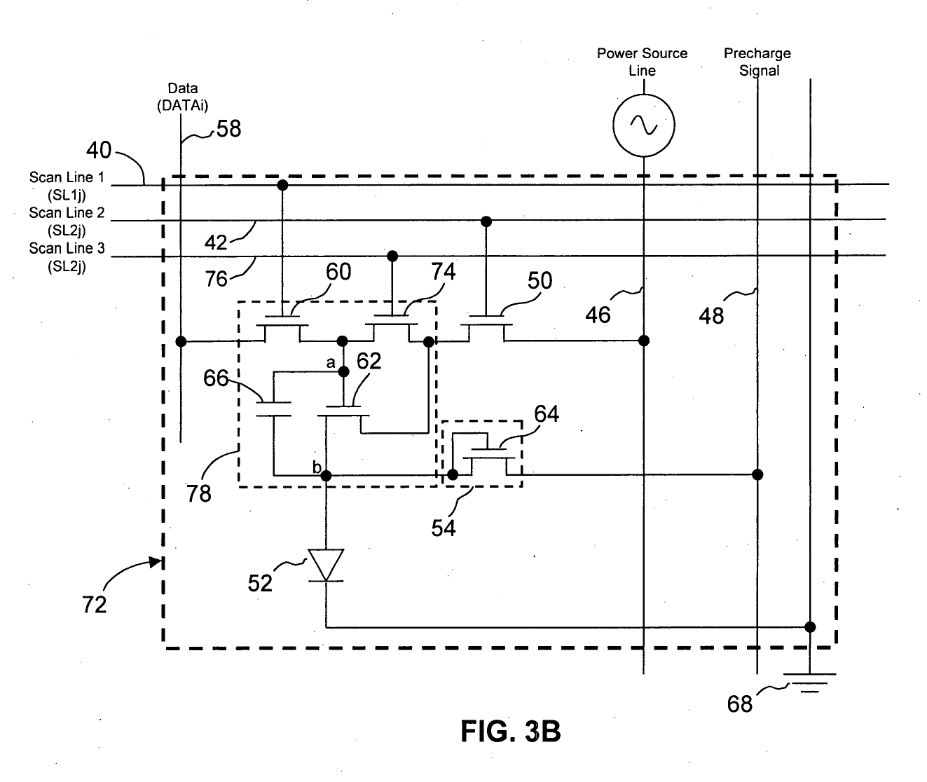

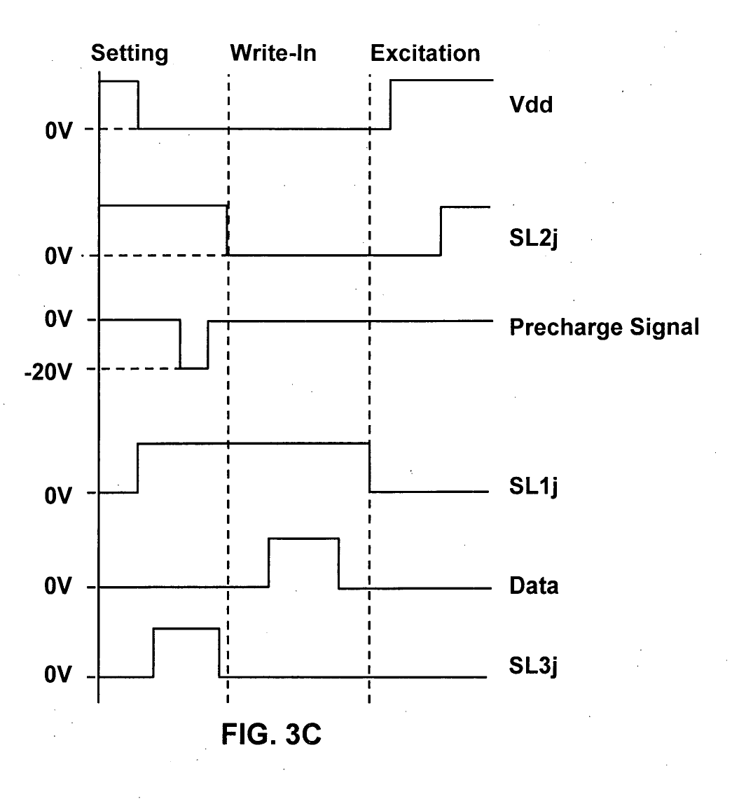

A second preferred embodiment of the present invention is shown in FIGS. 3A-C in a block diagram, a circuit diagram and in a timing sequence chart of pixel 72. As shown in FIG. 3A-B, the circuit of this embodiment is similar to that shown in FIG. 2A-B, i.e. it is formed by transistor 50, a pixel control unit 78, which is similar to pixel control unit 214 of FIG. 2A-B, OLED 52, and precharge control component 54. The major difference between this embodiment and the embodiment of FIG. 2 is the additional transistor 74 contained in the pixel control unit 78. The first terminal of transistor 74 is coupled to the gate terminal of transistor 62, the second terminal is connected to the third scan line, and the third terminal is coupled to another terminal of transistor 62.

Referring now to FIG. 3C, wherein the operation mode of the pixel circuit of FIG. 3B is shown. The operation mode similarly consists of three phases of setting, writing-in and excitation. During the setting phase, the third scan line is set to a high voltage potential in order to conduct through transistor 74, and to ensure the gate terminal voltage of transistor 62 is dropped to 0V. In order to calculate the threshold voltage of transistor 62. The subsequent write-in and excitation phase are similar to that shown in FIG. 2.

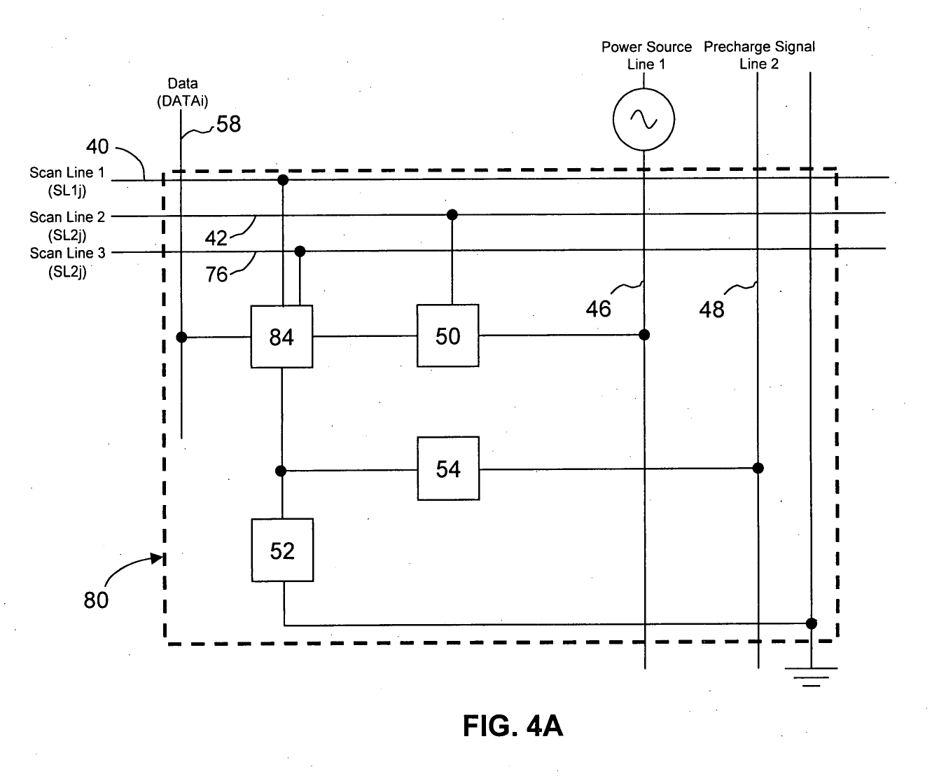

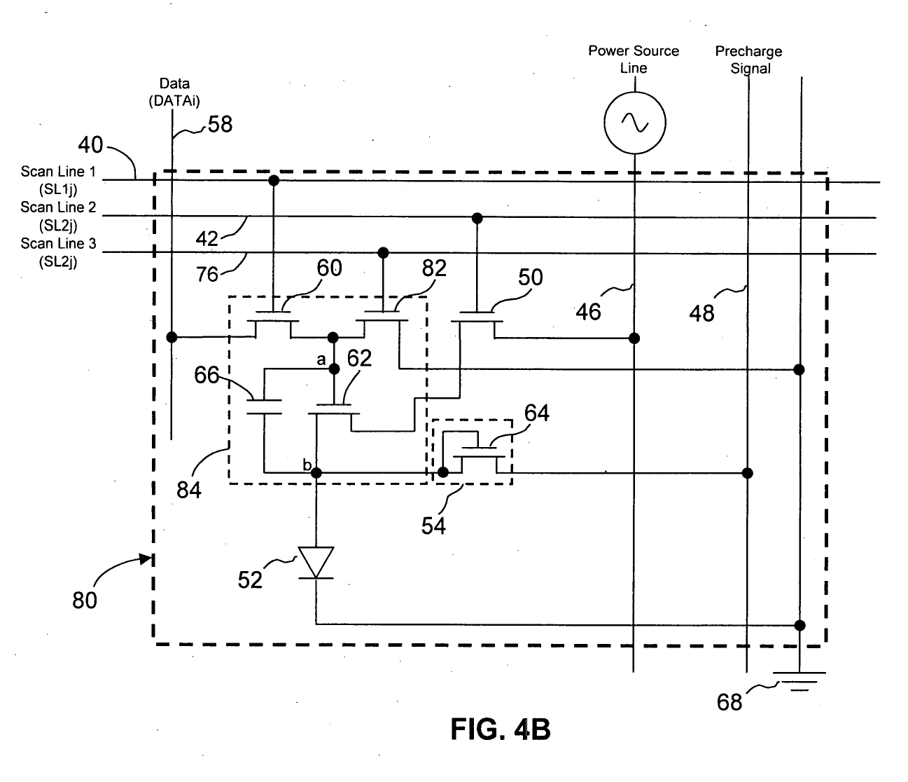

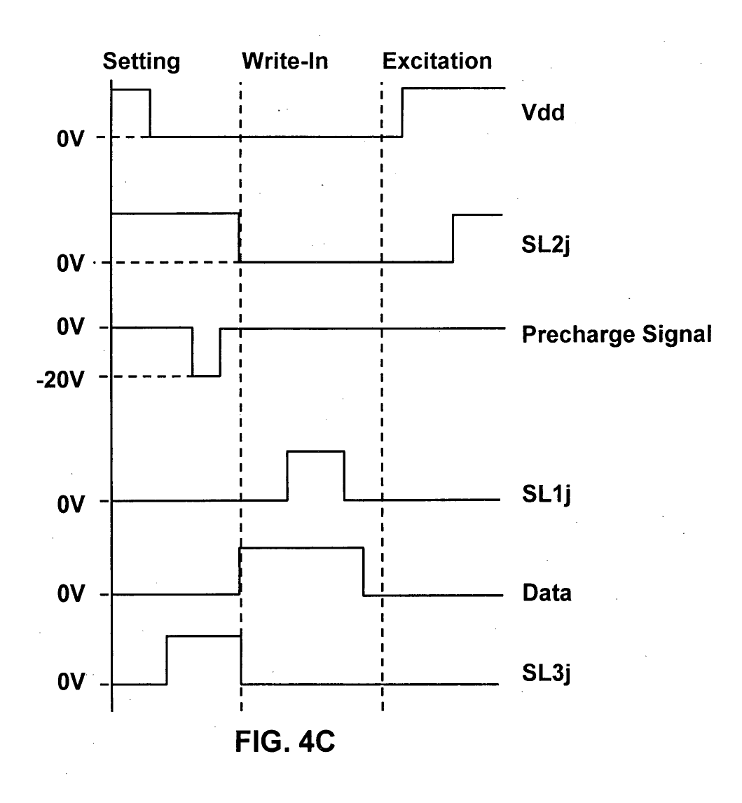

A third embodiment of the present invention OLED that is equipped with a current control method and voltage compensation function is shown in FIGS. 4A-C, in a circuit diagram and timing sequence chart of pixel 80, respectively. As shown in FIG. 4A-B, the circuit consists of transistor 50, pixel control unit 84, OLED 52 and the control component 54. The only difference compared to that shown in FIG. 2 is the additional transistor 82 in the pixel control unit 84. The additional transistor 82 has a first terminal coupled to the gate terminal of transistor 62, a second terminal receiving a third scan line, and a third terminal coupled to ground.

Referring now to FIG. 4C, wherein the operation mode of the third preferred embodiment is shown and is similar to that of FIG. 2B divided into a setting, data write-in at excitation phases. Similar to the timing sequence chart of FIG. 3C. During the setting phase, the third scan line is set to a high voltage potential to conduct through transistor 82, and to let the terminal gate of transistor 62 to reach 0V such that the threshold voltage of transistor 62 can be calculated. The subsequent phases of data write-in and excitation are similar to that previously shown in FIG. 2.

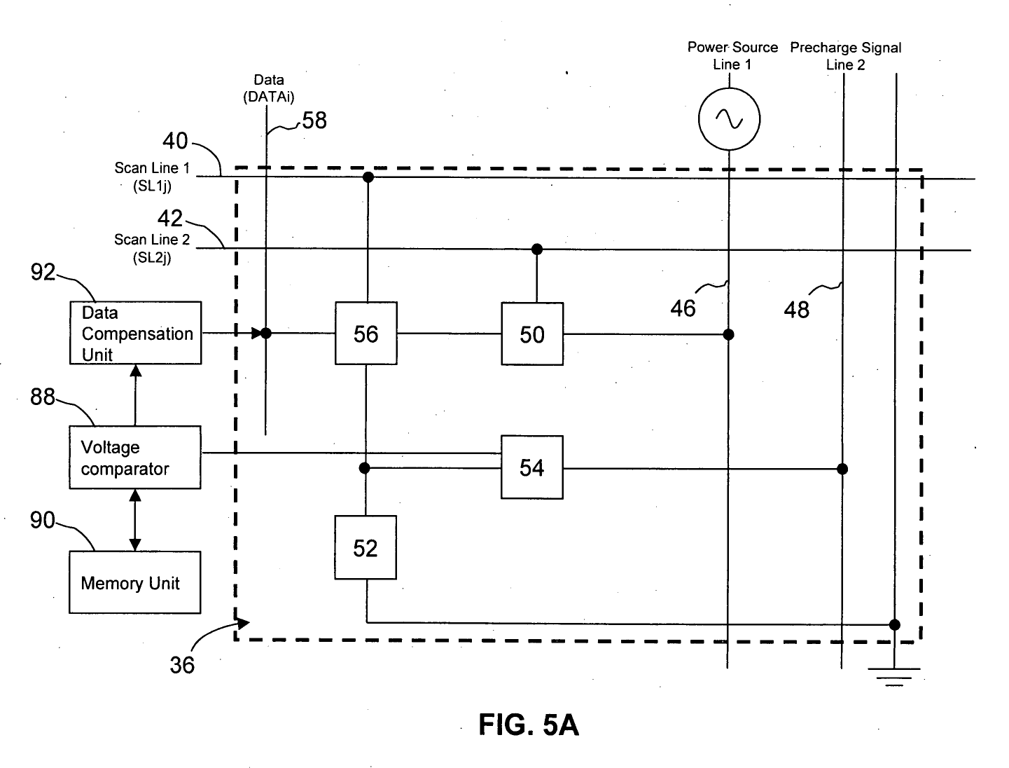

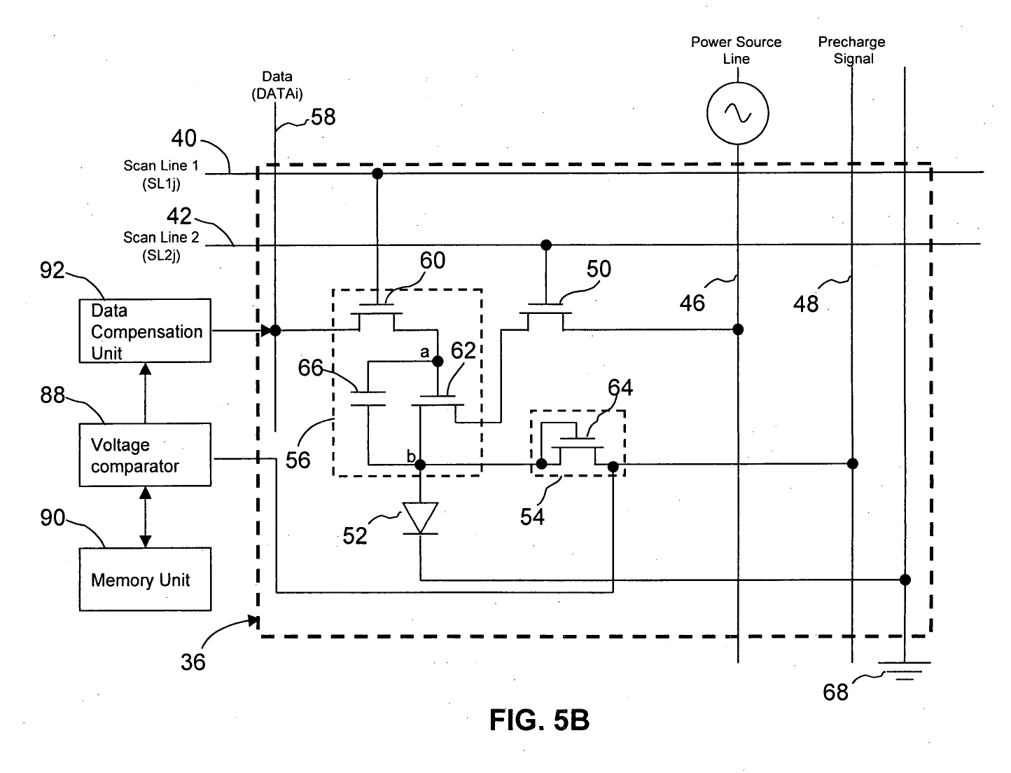

A fourth preferred embodiment of the present invention wherein the OLED circuit allows both voltage compensation and color compensation as shown in FIGS. 5A-B. The circuit of the fourth preferred embodiment is similar to that of the first embodiment shown in FIG. 2 except that the precharge control component 54 is a optoelectronic component thin film transistor (TFT) 94. In addition, the circuit further includes a voltage comparator unit 88, a memory unit 90, and a data compensation unit 92.

The operation of the fourth preferred embodiment shown in FIGS. 5A-B can be described as follows. When the OLED 52 in the circuit is excited, the TFT 94 is exposed to visible light source and thus producing an auto electronic current. The magnitude of the optoelectronic current is dependent on the intensity of the visible light. When a flat display panel utilizing OLED is first exposed, the optoelectronic component TFT 94 is first exposed to an initial brightness of the OLED. The initial optoelectronic current produced is further stored into memory unit 90. Subsequently, when the flat panel display is turned on, the optoelectronic component TFT 94 responds to the initial brightness of the OLED and transports an optoelectronic current to the voltage comparator unit 88 to compare with the initial optoelectronic current stored in the memory unit. The result of comparison is then sent to the data compensation unit 92, which adjusts the voltage of Vdata based on the comparison result. This enables the OLED component 52 to maintain at a fixed brightness in order to avoid a deterioration of the brightness after long time operation of the display panel.

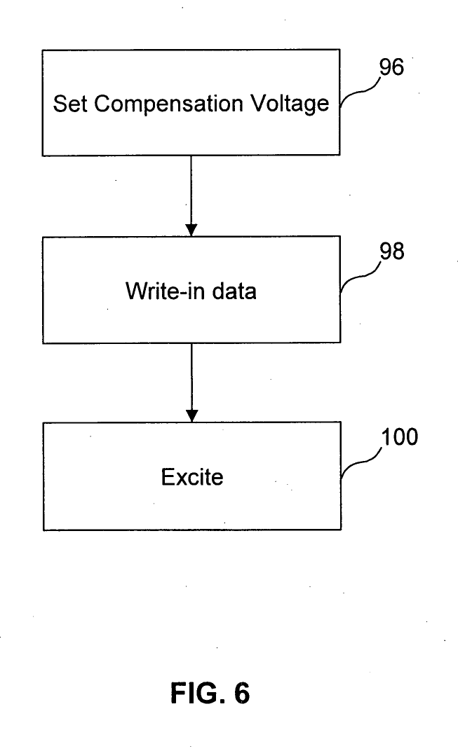

The present invention method for voltage compensation for an OLED circuit is shown in a flow chart in FIG. 7. Based on the circuit shown in FIG. 2A-C, Step 96 sets the compensating voltage of the pixel control unit. After the compensating voltage is set, the data is written-in during Step 98. Finally, during Step 100 the OLED is excited into an excitation state. The detailed operation of these three steps have been shown and explained in relation to FIGS. 2, 4.

What is claimed is:

1. An organic light emitting diode circuit comprising:
an OLED; and
an OLED driving device in electrical communication with the OLED, wherein the OLED driving device operates to provide a constant current through the OLED during excitation of the OLED, and wherein the OLED and the OLED driving device cooperate to form a pixel.

2. The organic light emitting diode circuit of claim 1, wherein the OLED driving device in electrical communication with the OLED comprises:
a pixel control unit,
a first transistor, the first transistor having a first terminal for receiving a voltage signal, a second terminal for receiving a second scanning line signal, and a third terminal for coupling to the pixel control unit; and
a precharge control component, the precharge control component having a first terminal coupled to the pixel control unit, and a second terminal for receiving a precharge electrical signal.

3. The organic light emitting diode circuit of claim 2, wherein the light emitting diode comprises:
a first terminal coupled to the pixel control unit, and
a second terminal connected to ground.

4. The organic light emitting diode circuit of claim 2, wherein the pixel control unit receives a first scan line and a data current write-in signal, and then utilizes the first scan line to determine whether the data current write-in signal is used to control a flow of current between a first transistor and the organic light emitting diode.

5. An organic light emitting diode circuit having voltage compensation function comprising:
a pixel control unit;
a precharge control component, the precharge control component having a first terminal coupled to the pixel control unit, and a second terminal for receiving a precharge electrical signal;
a first transistor, the first transistor having a first terminal for receiving a voltage signal, a second terminal for receiving a second scanning line signal, and a third terminal for coupling to the pixel control unit; and
an organic light emitting diode, the light emitting diode having a first terminal coupled to the pixel control unit, and a second terminal connected to ground.

6. The organic light emitting diode circuit of claim 5, wherein the pixel control unit receives a first scanning line signal and a data signal, and then utilizes the first scan line to determine whether the data signal is used to control a flow of current between a first transistor and the organic light emitting diode.

7. The organic light emitting diode circuit of claim 5, wherein the first scanning line signal and the second scanning line signal are voltage signals.

8. The organic light emitting diode circuit of claim 5, wherein the precharge control component is a second-transistor, the second transistor having a first terminal coupled to the pixel control unit, a second terminal coupled to the first terminal of the second transistor, a third terminal for receiving the precharge electrical signal such that when a compensating voltage in the pixel control unit is set to enable the precharge electrical signal to reach a voltage for forming an electrical circuit loop between the first transistor, the pixel control unit and the precharge control component, wherein the second terminal is a gate electrode of the second transistor.

9. The organic light emitting diode circuit of claim 5, wherein the pixel control unit further comprising:
a second transistor having a first terminal for receiving the data signal and second terminal for receiving the first scanning line signal;
a third transistor having a first terminal coupled to a third terminal of the first transistor, a second terminal coupled to a third terminal of the second transistor, and a third terminal coupled to a first terminal of the organic light emitting diode and a first terminal of the control component; and
a capacitor having a first terminal coupled to a third terminal of the second transistor, a second terminal coupled to a third terminal of the third transistor.

10. The organic light emitting diode circuit of claim 5, wherein pixel control unit further comprising:
the second transistor having the first terminal for receiving data signal, the second terminal for receiving the first scan line;
the third transistor having the first terminal coupled to the third terminal of the first transistor, the second terminal coupled to the third terminal of the second transistor, the third terminal coupled to the first terminal of the organic light emitting diode and the first terminal of the precharge control component;
a fourth transistor having a first terminal coupled to the third terminal of the second transistor, a second terminal for receiving a third scan line, and a third terminal for coupling to the third terminal of the first transistor; and
a capacitor, the capacitor having a first end coupled to the third terminal of the second transistor, and a second coupled to the third terminal of the third transistor.

11. The organic light emitting diode circuit of claim 5, wherein the pixel control unit further comprises:
a second transistor having a first terminal for receiving the data signal, and a second terminal for receiving the first scan line;
a third transistor having a first terminal coupled to a third terminal for the first transistor, a second terminal coupled to a third terminal of the second transistor, and a third terminal coupled to a first terminal of the organic light emitting diode and a first terminal of the precharge control component;
a fourth transistor having a first terminal coupled to the third terminal of the second transistor, a second terminal for receiving a third scan line, and a third terminal for coupling to ground; and
a capacitor having a first end coupled to the third terminal of the second transistor, a second end coupled to the third terminal of the third transistor.

12. The organic light emitting diode circuit of claim 5, further comprising:
a voltage comparator unit, the voltage comparator unit is coupled to a second terminal of the precharge control component for receiving a voltage signal and outputting a comparison signal;
a memory unit for storing an initial value of the voltage signal and then supplying the initial value of the voltage signal to the voltage comparator unit; and
a data compensating unit for receiving and then based on the comparison signal to output a compensating signal for adjusting the voltage value of the data signal.

13. The organic light emitting diode circuit of claim 12 wherein the comparison signal from the voltage comparator unit is generated after a comparison operation conducted between the voltage signal and the initial value of the voltage signal.

14. The organic light emitting diode circuit of claim 12 wherein the precharge control component is an optoelectronic component.

15. The organic light emitting diode circuit of 15 wherein the optoelectronic component is an optoelectronic thin film transistor, the optoelectronic thin film transistor having a first terminal coupled to the pixel control unit, a second terminal coupled to a first terminal of the optoelectronic thin film transistor, and a third terminal connected to a precharge voltage signal, wherein the second terminal of the optoelectronic thin film transistor is a gate electrode.

16. A method of controlling current through an organic light emitting diode comprising the steps of:
providing an organic light emitting diode circuit comprising a first transistor, a pixel control unit, a precharge control component and an organic light emitting diode; and
using the organic light emitting diode circuit to maintain a constant current flow through the organic light emitting diode.

17. The method of claim 16, wherein the pixel control unit receives a first scan line and a data write-in signal, the first transistor having a first terminal for receiving a voltage signal, a second terminal for receiving a second scan line, and a third terminal coupled to the pixel control unit; the precharge control component having a first terminal coupled to the pixel control unit, a second terminal for receiving a precharge voltage signal; and the organic light emitting diode having a first terminal coupled to the pixel control unit, and a second terminal coupled to ground.

18. The method of claim 16 further comprising the steps of:
setting the second scan line to a voltage sufficient to induce current to flow through the first transistor;
setting the supply voltage signal and the precharge control signal such that a current loop is formed between the first transistor, the pixel control unit and the precharge control component wherein when the supply voltage signal and the precharge control signal is set, a compensating voltage is provided in the pixel control unit;
setting the precharge control signal to a voltage sufficient to stop current flowing through the first transistor, and write-in the data current write-in signal; and
setting the precharge signal and the supply voltage signal to a voltage sufficient for the excitation of the organic light emitting diode and causing an excitation of the organic light emitting diode.

19. A method of providing a constant current flow through an OLED comprising the steps of:
providing a pixel control unit, and an OLED, wherein the pixel control unit operates to drive the OLED;
setting a compensating voltage of the pixel control unit;
writing data into the pixel control unit once the compensation voltage of the pixel control unit is set; and
exciting the OLED to turn on after data is written into the pixel control unit.

20. A method of providing an active matrix OLED display comprising the steps of:
providing a plurality of pixels, each of the plurality of pixels have an a pixel control unit, an OLED, and a common cathode, wherein the pixel control unit operates to drive the OLED;
setting a compensating voltage of each of the pixel control units;
writing data into each of the pixel control units once the compensation voltage of each of the pixel control units is set; and
exciting each of the OLEDs to turn on after data is written into each of respective the pixel control unit.

21. A method for voltage compensation of an organic light emitting diode circuit comprising the steps of:
providing an organic light emitting diode circuit comprising a first transistor, a pixel control unit, a precharge control component and an organic light emitting diode wherein the pixel control unit receives a first scan line and a data signal, the first transistor having a first terminal for receiving a voltage signal, a second terminal for receiving a second scan line, and a third terminal coupled to the pixel control unit; the precharge control component having a first terminal coupled to the pixel control unit, a second terminal for receiving a precharge voltage signal; and the organic light emitting diode having a first terminal coupled to the pixel control unit, and a second terminal coupled to ground;
setting the second scan line to a voltage sufficient to induce current to flow through the first transistor;
setting the supply voltage signal and the precharge control signal such that a current loop is formed between the first transistor, the pixel control unit and the precharge control component, wherein when the supply voltage signal and the precharge control signal is set, a compensating voltage is provided in the pixel control unit;
setting the precharge control signal to a voltage sufficient to stop current flowing through the first transistor, and write-in the data current write-in signal; and
setting the precharge signal and the supply voltage signal to a voltage sufficient for the excitation of the organic light emitting diode and causing an excitation of the organic light emitting diode.

22. The method of claim 21, further comprising the step of:
setting the precharge signal to a voltage sufficient to prevent current flow through the precharge control component during the data signal write-in phase and the excitation phase.

23. The method of claim 21 further comprising the step of:
setting the first scan line to a voltage sufficient for sending the data signal through the date line during the data current write-in phase.
